(19) United States
(12) Patent Application Publication
(10) Pub. No.: US 2012/0200267 A1
(43) Pub. Date: Aug. 9, 2012

(54) System for Storing Electric Energy

(76) Inventor: Conrad Rossel, Syrgenstein (DE)

(21) Appl. No.: 13/391,611

(22) PCT Filed: Jul. 16, 2010
(86) PCT No.: PCT/EP10/04352

§ 371 Date: Apr. 25, 2012

(30) Foreign Application Priority Data
Aug. 27, 2009 (DE) 10-2009-039-160.6

(51) Int. Cl. H02J 7/00

(52) U.S. Cl. 320/167; 320/166

(57) ABSTRACT

The invention concerns a system for storing electric energy, which comprises a plurality of storage cells, which have each an operating voltage. An electrical load as well as a switching element are arranged in series with the load in parallel to a storage cell. The switching element is closed when reaching or exceeding a threshold voltage. The system includes a control device, which is arranged in order to control the switching element in such a way that the storage cell is discharged via the electrical load. The invention moreover concerns a storage cell for storing electric energy.

The invention concerns a system for storing electric energy as defined more in detail in the preamble of claim 1. The invention moreover concerns a storage cell for storing electric energy.

Systems for storing electric energy, and here in particular for storing electric traction energy in electric vehicles or in particular in hybrid vehicles, are known from the general state of the art. Such systems for storing electric energy typically include individual storage cells which are for instance electrically linked together in series and/or in parallel.

Various accumulator cells or capacitor cells can basically be contemplated as storage cells. Due to the comparatively high energy amounts and in particular to the high performances, which occur for storing and tapping energy in case of use in drive trains of vehicles and here in particular of utility vehicles, the storage cells used are preferably those with sufficient energy content and high performance. To do so, accumulator cells can for instance be used in the lithium-ion technology or in particular storage cells in the form of very powerful double-layer capacitors. These capacitors are designated in professional circles also as supercapacitors, supercaps or ultracapacitors. Regardless of whether conventional supercapacitors or accumulator cells with high energy content are now used, the voltage of the various storage cells, due to their design, is limited to an upper voltage value or a threshold voltage with systems consisting of a plurality of storage cells which can be linked as a whole or also in blocks in series to one another. The lifetime of the storage cell generally decreases drastically if said upper voltage value is exceeded for instance when charging the system for storing electric energy.

Due to preset manufacturing tolerances, the individual storage cells typically deviate slightly in their properties from each other for instance in terms of self-discharge. The consequence is that in service a slightly smaller operating voltage than for other storage cells can be available in the system for individual storage cells. Since the maximum voltage however remains equal generally for the whole system and the maximum total voltage represents the typical actuation criterion in particular during charging, the effect is invariably that other storage cells which are connected in series to the storage cells with lower operating voltage, have a somewhat higher voltage and are charged beyond the admissible individual maximum voltage limit during charging processes. Such an overvoltage leads, as already mentioned above, to a considerable reduction in the possible lifetime of said individual storage cells and hence also of the whole system for storing electric energy.

To cope with such problems, the general art mainly offers two different types of so-called cell voltage balances. The generally usual terminology of the “cell voltage balance” is here somewhat deceptive since here voltages or more precisely energy contents of the individual storage cells are not balancer to one another, but the cells with too high voltages see their voltages reduced. Since the total voltage of the system for storing electric energy remains constant, a cell whose voltage has been lowered, can be restored over time to its voltage via the so-called cell voltage balance so that at least the danger of polarity reversal is reduced.

An active cell voltage balance is also introduced in addition to a passive cell voltage balance in which an electrical resistor is switched in parallel to each individual storage cell and consequently there is a steady undesirable discharge as well as a heating of the system for storing electric energy. To do so, in addition to the resistor connected in parallel to each individual storage cell, an electrical threshold switch is connected in parallel to the storage cell and in series to the resistor. Said assembly also designated as a by-pass electronic assembly hence only lets current flow when the operating voltage of the cell lies above a preset threshold voltage. As soon as the voltage of the individual storage cell returns to a region below the preset threshold voltage, the switch opens and no current flows any longer. Due to the fact that the electrical resistor is always deactivated via the switch when the voltage of the individual storage cells is below the preset limit value, an undesirable discharge of the whole system for storing electric energy can extensively be avoided. Also a steady undesirable heat generation is not a problem with that approach to the active cell voltage balance.

A supercapacitor storage unit for instance for hybrid city busses typically consists of several hundred supercapacitor cells connected in series which are mostly split into several modules. In the case of upcoming service or repair works on the vehicle or especially on a hybrid system, the supercapacitor storage unit is more advantageously discharged before said works so as to exclude any risk for the service or repair staff. This requires some handling with appropriate external components to be made available additionally by connections which can be under dangerously high voltages according to the charge level and via which very high performances are conveyed. Furthermore, these connections are among others hardly accessible so that these operations should be carried out by particularly qualified staff only.

Further, it is disadvantageous with this method that cells, which in comparison to other storage cells have a lower charge level or a smaller capacity, can have their poles reversed, if the whole storage device or the whole module is discharged. These differences in charge level or capacity of the storage cells derive for instance from manufacturing tolerances which can result in an increased self-discharge as well as in distinct quick altering of the storage cells due to for instance uneven cooling in the module or in the whole storage device. Such a polarity reversal reduces the lifetime of the corresponding storage cells and should be avoided.

The lifetime of the system for storing electric energy is of vital importance with the described hybrid drive and here in particular with hybrid drives for utility vehicles such as omnibusses in urban and local traffic. Unlike with conventional drive trains in the performance category appropriate for such applications, the system for storing electric energy represents a considerable portion of the costs for the hybrid drive. It is hence especially important that quite high lifetimes can be achieved with such applications.

It is hence an object of the invention to provide a system for storing electric energy as well as a storage cell which respectively avoids the described shortcomings at least partially and reduces the probability of polarity reversal in particular in case of discharge of the system or of the storage cell. This object is mat by a system and a storage cell having the features of the independent claims. Further embodiments of the invention are disclosed in the dependent claims.

In particular, the invention sets forth a system for storing electric energy, comprising a plurality of storage cells, which have each an operating voltage, whereas an electrical load as well as a switching element in series with the load are arranged in parallel to a storage cell and whereas the switching element is closed when reaching or exceeding a threshold voltage. The system includes a control device according to the invention, which is arranged in order to control the switching element in such a way that the storage cell is discharged via the electrical load.

It is hence possible according to the invention to specifically trigger a discharge of the storage cells via the electrical load by operating the switching element by means of the control device and consequently to discharge the system in complete safety so that maintenance and repair works can be carried out. The handling with connections under high voltage can be avoided through the provision of a control device.

It is provided in an advantageous embodiment that the storage cell can be discharged via the electrical load to a discharge voltage. It is thus guaranteed that the system for storing electric energy is discharged to or below a voltage value, here mentioned as a discharge voltage, at which any manipulation of the system or of individual modules thereof can be performed safely.

A particularly advantageous embodiment of the invention sets forth that the switching element can be controlled via a contact-free transmission device. It can thus in particular be provided that the contact-free transmission device is an isolation amplifier, in particular an optocoupler. This enables to distinguish between lines and devices, via which energy is conveyed to the storage device or via which energy is tapped from the storage device, and control lines as well as control devices which are used by the service or maintenance staff. In particular, a galvanic separation is possible between control lines and lines conveying a high voltage so that particular high safety can be obtained. The isolation amplifier can alternately be realised also by an inductive or possibly a capacitive coupling and thus also enables actuation of the switching element, galvanically separated from the storage cells.

As regards the configuration of the contact-free transmission device, it can be provided on the one hand that a contact-free transmission device is allocated to each storage cell from the plurality of storage cells. This enables targeted actuation of each storage cell and thus a particularly safe and careful discharge for the individual storage cell. It is particularly advantageous in this context that the contact-free transmission device is arranged at the storage cell. There is hence a direct as well as spatial allocation of the contact-free transmission device to the storage cell.

It can alternately be provided that a contact-free transmission device is allocated to a plurality of storage cells. In such a case, a contact-free transmission device can for instance activate two neighbouring cells or an entire module, consisting of several storage cells. This reduces the means implemented in terms of switches and electronics and hence represents an alternative whose realisation is particularly cost efficient. In this regard it can be provided that the contact-free transmission device is arranged by the control device. The transmission device can then be integrated into the control device or be arranged in its spatial vicinity.

An embodiment of the invention sets forth that the control of the switching element may influence the threshold voltage. The threshold voltage of the storage cell can for instance be operated on the discharge voltage so that the storage cell is discharged via the electrical load.

It can alternately also be provided that the switching element can be closed by the control load. The consequence is direct actuation of the switching process of the switching element by the control load without taking the threshold voltage into account.

It is provided in an advantageous further embodiment of the invention that the control device is connected to the switching element by means of a bus line. This enables efficient actuation of a plurality of storage cells. In such a case, not only the forwarding of the discharge signal or of the threshold voltage modified to the discharge voltage can in particular be provided from the control device to the storage cell but also for instance the forwarding of the current operating voltage or of the current threshold voltage from the storage cell to the control device. This enables for instance to create a precise replication of the storage level of the system for storing electric energy or of each detected module of the system, respectively.

In a simple embodiment of the invention, the load is a resistor but also other means for evacuating electric energy, such as for instance by means of beamed radiation can be provided. The storage cell can be designed as a so-called supercapacitor, i.e. as a double-layer capacitor.

In a simple embodiment, the switching element can be a threshold switch. As already explained, the control device can then set either the threshold of the threshold switch on the discharge voltage or directly activate the switching process of the threshold switch by means of a signal bus or data bus. A combination of both concepts can also be used if necessary.

The system according to the invention can be mounted particularly advantageous in an energy storage device, in particular for hybrid drives.

The object mentioned initially is also solved with a storage cell for storing electric energy, with an electrical load which is arranged parallel to the storage cell as well as with a switching element which is arranged in series with the device, whereas the switching element is closed when reaching or exceeding a threshold voltage. According to the invention it is provided that the switching element can be activated via a contact-free transmission device in such a way that the voltage of the storage cell falls down to or below a discharge voltage. In that case, the contact-free transmission device can be arranged directly on the switching element or connected to the contact-free transmission device via an appropriate signal or data line. The contact-free transmission device can be for instance an isolation amplifier, in particular an optocoupler.

Further advantageous embodiments of the system according to the invention as well as of the storage cells according to the invention can be seen in the exemplary embodiment, which is described more in detail below in the light of the figures.

The figures are as follows:

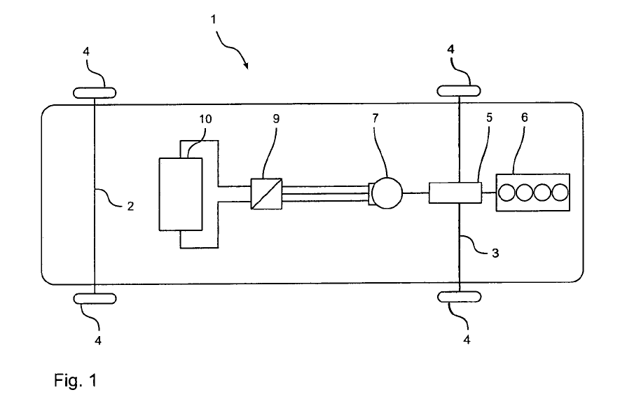

FIG. 1 is an exemplary assembly of a hybrid vehicle; and

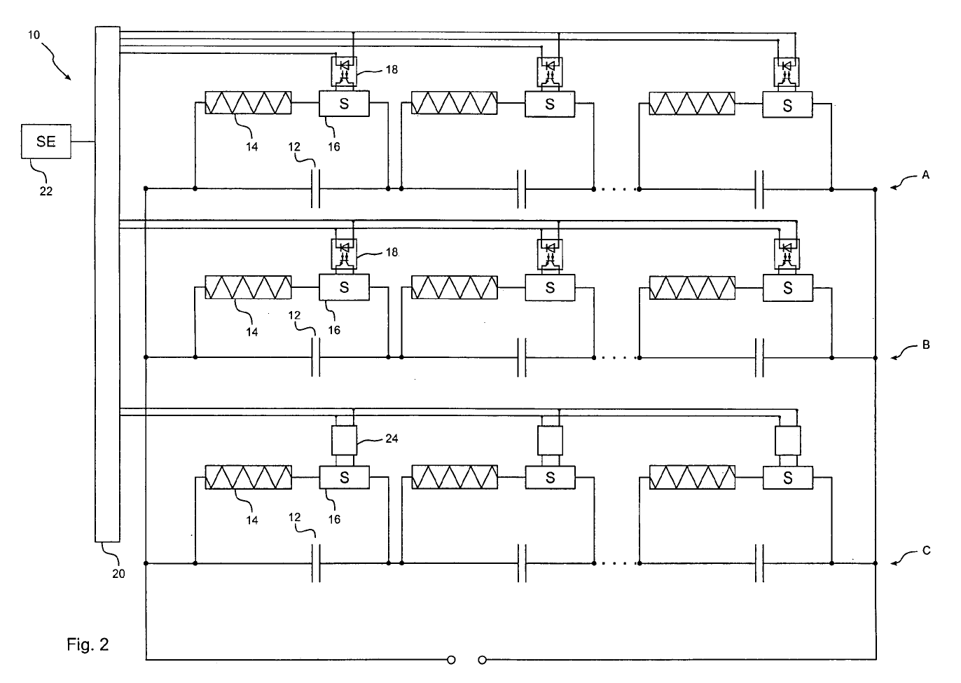

FIG. 2 is a diagrammatical illustration of an embodiment of a system for storing electric energy.

FIG. 1 refers to an exemplary hybrid vehicle 1. It has two axles 2, 3 each with two wheels 4 indicated by way of example. The axle 3 should hence be a driven axle of the vehicle 1, while the axle 2 exclusively rotates therewith in a manner known per se. A transmission 5 is represented by way of example for driving the axle, a transmission which picks up the power from a internal combustion engine 6 and from an electrical machine 7 and conveys it into the region of the driven axle 3. In service, the electrical machine 7 on its own or in complement to the drive power of the internal combustion engine 6 can guide the drive power into the region of the driven axle 3 and hence drive the vehicle 1 or support the actuation of the vehicle 1. Moreover, the electrical machine 7 can be operated moreover as a generator when braking down the vehicle 1 so as to recover the power produced during when braking and to store it accordingly. To be able to supply a sufficient energy content for instance when using the vehicle 1 as a city bus, as well as for braking processes from higher speeds which can be commonly about max. 70 km/h, a system 10 for storing electric energy should be provided for such a case with an energy content in the order of magnitude of 350-700 Wh. This enables to store energies which for instance occur with a braking cycle of around 10 seconds from said speeds, which can be converted into electric energy, via the electrical machine 7, which typically have an order of magnitude of approx. 150 kW.

For operating the electrical machine 7 as well as for charging or discharging the system 10 for storing electric energy, the assembly according to FIG. 1 has a converter which is designed in a manner known per se as an integrated control device for energy management. The energy flow between the electrical machine 7 and the system 10 for storing electric energy is accordingly coordinated via the converter 9 with the integrated control device. The control device sees to it that when braking, the power produced in the region of the electrical machine 7 which is driven by a generator, is then, as much as possible, stored into the system 10 for storing electric energy whereas a preset upper voltage limit of the system 10 generally should not be exceeded. In service, the control device in the converter 9 coordinates the tapping of electric energy from the system 10, in order in this reverse case to drive the electrical machine 7 by means of this tapped power. In addition to the hybrid vehicle 1 described here, as it can be designed for instance as a city bus, it goes without saying that a comparable assembly could also be envisioned in a pure electric vehicle.

FIG. 2 shows diagrammatically a cut-out of a system 10 according to the invention for storing electric energy according to an embodiment. As a matter of principle, different types of the system 10 for storing electric energy can be envisioned. Such a system 10 is typically built up in such a way that a plurality of storage cells 12 are connected in the system 10 typically in series. These storage cells can hence be accumulator cells and/or supercapacitor cells or any combination thereof. For the exemplary embodiment represented here, all of the storage cells 12 can be designed as supercapacitors, that is to say as double-layer capacitors, which are installed in a single system 10 for storing electric energy in the vehicle 1 equipped with the hybrid drive. But the assembly can preferably be mounted in a utility vehicle, for instance an omnibus for the city and local traffic.

In this context, frequent starting and braking maneuvres in connection with a very high vehicle mass enable to achieve a particularly highly efficient storage of electric energy through the supercapacitors since comparatively high currents flow. Since supercapacitors as storage cells 12 have much smaller internal resistor than for instance accumulator cells, the former should hence be preferred for the exemplary embodiment which is described in more detail here.

As already mentioned, the storage cells 12 can be seen in FIG. 2. In that case, only three of several storage cells 12 connected in series are depicted. These form in a row of storage cells (not shown further) a first module A. Additional modules B, C are also depicted schematically. The exact number of modules varies depending on the intended use of the system. In the exemplary embodiment above and with a corresponding electrical drive power of about 100-200 kW, for instance 120 kW, this would mean in a realistic assembly a total of approximately 150-250 storage cells 12. If these are designed as supercapacitors with a current upper voltage limit of about 2.7 V per supercapacitor and a capacity of 3000 Farads it would provide a realistic application for the hybrid drive of a city omnibus.

As illustrated in FIG. 2, each of the storage cells 12 has an electrical load connected in parallel to the respective storage cell 12 in the form of an ohmic resistor 14. Said load is connected in series with a switching element 16 in parallel to each of the storage cells 12, in such a case in parallel to each of the supercapacitors 12. The switch 16 is designed as a threshold switch and only represented schematically. The switching element 16 comprises a voltage monitoring of the supercapacitor 12. As soon as the supercapacitor 12 exceeds an upper threshold voltage, the switch 16 is closed so that a current can flow from the supercapacitor 12 over the resistor 14. To do so, the charge situated in the capacitor and hence the voltage are reduced accordingly.

Moreover, the threshold switch 16 is connected via an optocoupler 18 and corresponding data or signal lines to a bus 20. A control device 22 is also connected to the data bus 20. The control device is designed to control the optocoupler 18 which is arranged on the storage cells 12, by means of the bus 20.

The storage cells 12, as already mentioned, are divided into modules A, B and C in the embodiments illustrated in FIG. 2. For illustrative purposes, various embodiments are depicted for the modules A, B and C. In a real system for storing electric energy, only identical modules would be implemented. The module A is, as already described, fitted with storage cells 12 whose threshold switch 16 can be activated via an optocoupler 18. To do so, the different optocouplers 18 of the respective storage cell 12 can be activated individually by the control device 22 via the data bus 20, which means that a discharge command can be issued for each particular storage cell 12.

The storage cells 12 of the module B conversely are admittedly provided with optocouplers 18 for controlling the threshold switch 16. Indeed, the connection of the optocoupler is realised in such a way that the discharge signal can be transferred to the threshold switch 16 only for all the optocouplers 18 together. Consequently, the module B is discharged uniformly for all the storage cells 12 contained therein.

The module C also has storage cells 12 which can be discharged via a threshold switch 16 and a resistor 14. Indeed, the threshold switch 16 is not activated via an optocoupler but via an inductive coupler 24. The connection is admittedly here also realised similarly to module B, which means that all the storage cells 12 can only be discharged uniformly. But this only represents an embodiment by way of example. It goes without saying that all the concepts of the modules A-C can be combined to one another at will.

A further variation, not illustrated here, consists in providing for a module, i.e. for several storage cells a single isolation amplifier which can transfer a uniform discharge command to the several storage cells.

Consequently, the invention makes use of the already present by-pass electronic assembly for discharging the storage device, inasmuch as their circuitry can be extended inexpensively. Said extension can thus be realised, as already mentioned, via an isolation amplifier such as for instance an optocoupler 18 or also via an inductive coupling 24. The by-pass electronics can be connected with a small signal voltage from outside the module or of the whole storage device via the control device 22 and via said isolation amplifier which can separate the by-pass electronics from each other and to the outside world from the high operating voltage by galvanisation. Said switching mode can be maintained until the supercapacitor cells 12 are completely discharged or until the total voltage of the system 10 has returned to a safe value. As already mentioned, the voltage of the various cells 12, of a whole module or the total voltage of the system can also be detected via the bus 20. Since every cell is discharged on its own, there is hence no danger of polarity reversal of the capacitors 12. With a leakage current of the by-pass electronics of 1 A, the cell voltage then sinks by 1 V in 50 minutes so that with this numerical example the storage device could be considered as discharged in approx. 2 hours. It also goes without saying that other leakage currents occur according to the electric load used.

The heat energy here produced can be evacuated via the cooling of the storage device or of the module, a cooling which is normally proper to these systems. Consequently, no additional precautionary measures need be taken.

1-15. (canceled)

16: A system for storing electric energy, comprising a plurality of storage cells, which have each an operating voltage, whereas an electrical load as well as a switching element in series with the electrical load are arranged in parallel to a storage cell and whereas the switching element is closed when reaching or exceeding a threshold voltage,
characterised in that
the system includes a control device, which is arranged in order to control the switching element in such a way that the storage cell can be discharged via the electrical load to a discharge voltage at which a manipulation of the system can be performed safely.

17: The system of claim 16, characterised in that the switching element can be controlled via a contact-free transmission device.

18: The system of claim 17, characterised in that the contact-free transmission device is an isolation amplifier, in particular an optocoupler.

19: The system of claim 17, characterised in that a contact-free transmission device is allocated to each storage cell from the plurality of storage cells.

20: The system of claim 19, characterised in that the contact-free transmission device is arranged at the storage cell.

21: The system of claim 17, characterised in that a contact-free transmission device is allocated to a plurality of storage cells.

22: The system of claim 21, characterised in that the contact-free transmission device is arranged at the control device.

23: The system of claim 16, characterised in that the controlling of the switching element may comprise influencing the threshold voltage.

24: The system of claim 17, characterised in that the controlling of the switching element may comprise influencing the threshold voltage.

25: The system of claim 18, characterised in that the controlling of the switching element may comprise influencing the threshold voltage.

26: The system of claim 19, characterised in that the controlling of the switching element may comprise influencing the threshold voltage.

27: The system of claim 20, characterised in that the controlling of the switching element may comprise influencing the threshold voltage.

28: The system of claim 21, characterised in that the controlling of the switching element may comprise influencing the threshold voltage.

29: The system of claim 22, characterised in that the controlling of the switching element may comprise influencing the threshold voltage.

30: The system of claim 16, characterised in that the switching element can be closed by the control device.

31: The system of claim 16, characterised in that the control device is connected to the switching element by means of a bus line.

32: The system of claim 16, characterised in that the load is a resistor and/or that the storage cell is a supercapacitor.

33: The system claim 16, characterised in that the switching element is a threshold switch.

34: The system of claim 16, characterised in that the system is used in an energy storage device, in particular for hybrid drives.

35: A storage cell for storing electric energy, with an electrical load which is arranged parallel to a storage cell as well as a switching element which is arranged in series with the load, whereas the switching element is closed when reaching or exceeding a threshold voltage,
characterised in that
that the switching element can be controlled via a contact-free transmission device in such a way that the voltage of the storage cell falls down to or below a discharge voltage, at which any manipulation of the storage cell can be performed safely.
